(19) United States
(12) Patent Application Publication
(10) Pub. No.: US 2011/0214055 A1
(43) Pub. Date: Sep. 1, 2011

(54) Systems and Methods for Using Structured Libraries of Gestures on Multi-Touch Clinical Systems

(75) Inventors: Emil Georgiev, Waukesha, WI (US); Gopal Avinash, Waukesha, WI (US); David Deaven, Waukesha, WI (US); Erik Kemper, Waukesha, WI (US); Sardar Mal Gautham, Waukesha, WI (US); Ananth Mohan, Waukesha, WI (US)

(73) Assignee: General Electric Company, Schenectady, NY (US)

(21) Appl. No.: 12/713,974

(22) Filed: Feb. 26, 2010

(51) Int. Cl. G06F 3/01

(52) U.S. Cl. 715/702; 715/863

(57) ABSTRACT

Systems, methods and computer-readable storage mediums encoded with instructions for providing touch-driven controls in a clinical setting are provided. Certain embodiments provide a system that includes a clinical system and a customizable structured library of functions. The structured library can include a function associated with a clinical context. The function can be associated with a user input requiring the use of a touch driven interface with multi-touch gestures. The user input can provide for immediate execution of the associated function. The structured library can be loaded onto the clinical system as a driver such that the function is made available based on the associated clinical context. Certain embodiments can include a user interface configured to allow a user to add or delete a function or modify the user input associated with a function. Certain embodiments can include a user interface that provides instruction as to using a function.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Touch-driven interfaces, such as touch-screens and touch-pads, for example, can provide for improved interaction with displayed information by reducing the number of steps it may take to accomplish the same interaction using a standard menu, keyboard and/or mouse. Touch-driven interfaces can sense inputs using a variety of means, such as heat, finger pressure, high capture rate cameras, infrared light, optic capture, and shadow capture, for example

Multi-touch interfaces can allow for multiple simultaneous inputs using such touch-driven interfaces. Certain computing devices utilize multi-touch interfaces to provide standard functionality, such as zooming, palming and/or scrolling, for example.

Touch-driven interfaces are presently underutilized in the clinical setting. Thus, there is a need for systems, methods and computer-readable storage mediums encoded with instructions for providing touch-driven controls in a clinical setting.

### BRIEF SUMMARY OF THE INVENTION

Embodiments of the present technology provide systems, methods and computer-readable storage mediums encoded with instructions for providing touch-driven controls in a clinical setting.

Certain embodiments provide a system comprising: a clinical system comprising a processing device operably connected to a storage medium and a touch-driven interface; and a customizable structured library of functions including a function associated with a clinical context, the function associated with a user input requiring the use of the touch driven interface with multi-touch gestures, the user input providing for immediate execution of the associated function, the structured library loaded onto the storage medium as a driver such that the function is made available based on the associated clinical context.

In certain embodiments, the clinical context includes a clinical application in a clinical area.

In certain embodiments, the clinical area includes at least one of: radiology, surgery, interventional radiology, patient monitoring, neurology, cardiology, vascular, oncology, or musculoskeletal.

In certain embodiments, the the clinical application includes at least one of: visualization, analysis, quantitation, detection, monitoring or differential diagnosis.

In certain embodiments, the clinical context includes a stage in a technology workflow using a technology enabler.

In certain embodiments, the stage in the technology workflow includes at least one of: screening, scheduling, image acquisition, data reconstruction, image processing, image display, image analysis, image storage, image retrieval, diagnosis, report creation, or result dissemination.

In certain embodiments, the technology enabler includes at least one of: review, segmentation, registration, selection, marking, or annotation.

In certain embodiments, the system can include a user interface configured to allow: a function to be added to the structured library, a function to be deleted from the structured library, and a user input associated with a function to be modified.

In certain embodiments, the system can include a user interface configured to provide instruction as to using a function in the structured library.

In certain embodiments, the touch-driven interface comprises at least one of: a touch-screen, or a touch-pad.

In certain embodiments, the touch-driven interface comprises a multi-touch interface configured to receive a plurality of simultaneous inputs from a plurality of users, and wherein the user input requires that the plurality of simultaneous inputs from the plurality of users be received at the touch-driven interface.

Certain embodiments provide a method including: using a processing device to load a customizable structured library of functions onto a storage medium in a clinical system that comprises a touch-driven interface, the structured library of functions including a function associated with a clinical context, the function associated with a user input requiring the use of the touch driven interface with multi-touch gestures, the user input providing for immediate execution of the associated function, the structured library loaded onto the storage medium as a driver such that the function is made available based on the associated clinical context.

In certain embodiments, the method further includes using a user interface to customize the structured library of functions.

In certain embodiments, the method further includes executing a function at the clinical system when a user input is received at the touch driven interface.

In certain embodiments, the method further includes using a user interface to provide instruction as to using a function in the structured library.

Certain embodiments provide a computer-readable storage medium encoded with a set of instructions for execution on a processing device and associated processing logic, wherein the set of instructions includes: a first routine configured to load a customizable structured library of functions onto a storage medium in a clinical system that comprises a touch-driven interface, the structured library of functions including a function associated with a clinical context, the function associated with a user input requiring the use of the touch driven interface with multi-touch gestures, the user input providing for immediate execution of the associated function, the structured library loaded onto the storage medium as a driver such that the function is made available based on the associated clinical context.

In certain embodiments, the instructions further include a second routine configured to allow the structured library to be customized.

In certain embodiments, the instructions further include a second routine configured to provide instruction as to using a function in the structured library.

### BRIEF DESCRIPTION OF THE DRAWINGS

FIG. 1 depicts a system for providing touch-driven controls in a clinical setting used in accordance with embodiments of the present technology.

FIG. 2 is a table depicting a structured library of functions used in accordance with embodiments of the present technology.

FIG. 3 is a table depicting various combinations of user inputs and devices used in accordance with embodiments of the present technology.

FIG. 4 depicts a flowchart for a method for providing touch-driven controls in a clinical setting used in accordance with embodiments of the present technology.

FIG. 5 depicts a user interface used in accordance with embodiments of the present technology.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Certain embodiments of the present technology provide systems, methods and computer-readable storage mediums encoded with instructions for providing touch-driven controls in a clinical setting. Certain embodiments are described below.

While the described embodiments may refer to specific imaging modalities, one skilled in the art will appreciate that the teachings herein can be applied across the full spectrum of imaging modalities. Also, while the described embodiments may refer to specific medical departments and clinical contexts, one skilled in the art will appreciate that the teachings herein can be applied across the full spectrum of medical departments and clinical contexts.

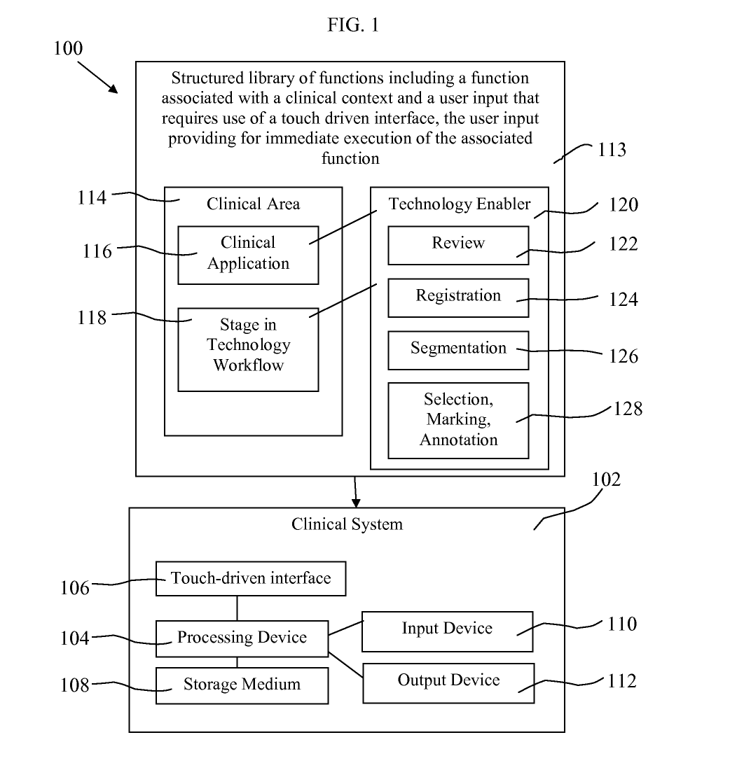

FIG. 1 depicts a system 100 for providing touch-driven controls in a clinical setting used in accordance with embodiments of the present technology. The system 100 includes a clinical system 102 that includes a processing device 104, a touch-driven interface 106, a storage medium 108, an input device 110 and an output device 112. Clinical system 102 can be a stand-alone workstation or can be in communication with other clinical systems and/or storage mediums using a wired or wireless connection. Clinical system 102 can access medical images located in storage and/or received from medical imaging devices, such as x-ray imaging devices, ultrasonic imaging devices, commuted tomography imaging devices, etc.

The components of clinical system 102 are operably connected to processing device 104, which can provide for interaction among the components of clinical system 102. Processing device 104 can comprise any suitable computer processor, for example.

Touch-driven interface 106 is configured to receive input from a user based on the user touching touch-driven interface 106. Touch-driven interface 106 can be a touch-screen that also functions as a display or a touch-pad that does not function as a display, for example. Touch-driven interface 106 can be configured to detect a user's touch in many ways. For example, touch-driven interface can be configured to detect a user's touch based on heat, finger pressure, high capture rate cameras, infrared light, optic capture, or shadow capture, for example. Touch driven interface 106 can be a multi-touch interface that can receive multiple user inputs simultaneously. Inputs requiring multiple simultaneous touch points to be received at a touch-based interface can be referred to as multi-touch gestures. In certain embodiments, a touch-driven interface can include one or more touch-screens and/or touch-pads.

Input device 110 is configured to receive input from a user, and can include a mouse, stylus, microphone and/or keyboard, for example. Output device 112 is configured to provide an output to a user, and can include a computer monitor, liquid crystal display screen, printer and/or speaker, for example.

Storage medium 108 is a computer-readable memory. For example, storage medium 108 can include a computer hard drive, a compact disc (“CD”) drive, a Digital Versatile Disc (or Digital Video Disc) (“DVD”) drive, a USB thumb drive, or any other type of tangible memory capable of storing one or more computer software applications and/or sets of instructions for a computer. The sets of instructions can include one or more routines capable of being run or performed by clinical system 102. Storage medium 108 can be included in a workstation or physically remote from a workstation. For example, storage medium 108 can be accessible by clinical system 102 through a wired or wireless network connection.

The system 100 also includes a structured library of functions 113. The structured library of functions 113 associates functions to be performed using clinical system 102 with a clinical context that can include: clinical areas 114, clinical applications 116, stages in a technology workflow 118 and/or technology enablers 120, for example. The structured library of functions 113 also associates functions to be performed using clinical system 102 with a user input that can require use of touch-driven interface 106. The structured library of functions 113 can be loaded onto storage medium 108 as a driver such that functions in the library are made available based on the associated clinical context. By doing so, the functions can be available to a user based on the task the user is attempting to accomplish, or, in other words, based on the stage of a treatment cycle.

In operation, functions, such as adjust window width, adjust window level, pan, and zoom, for example, can be associated with a user input, and can also be associated with a clinical context in which to make the function available. The clinical context can include a clinical area, clinical application, stage in a technology workflow, and/or technology enabler, for example.

In certain embodiments, each user input (or combination of simultaneous inputs) can be a shortcut that provides for immediate execution of a function. In such embodiments, a user can avoid the use of standard menus, that may require various user inputs before a function can be selected for execution.

In certain embodiments, each user input (or combination of simultaneous inputs) can include a gesture (or combination of gestures) that can provide for interaction with an image displayed on a touch-screen. In such cases, a user input may provide for manipulating the image (for example, by rotating the image), making markings on the image (for example, for annotation purposes) copying the image, and/or otherwise interacting with the image (for example, in any of the manners described herein). In certain embodiments, such user inputs can include gestures input by one or more users and received at one or more touch-based interfaces. In certain embodiments, more than one image can be displayed on a touch-screen, and multi-touch gestures can be simultaneously input using the touch-screen to interact with the respective images. For example, one image displayed on a touch-screen could be rotated while a second image displayed on the touch-screen could be made larger (using a zoom function),In certain embodiments, the structured library approach to making touch-based user inputs available based on clinical context can provide customized touch-driven controls in a clinical setting that can improve efficiency in performing clinical tasks and the clinical workflow.

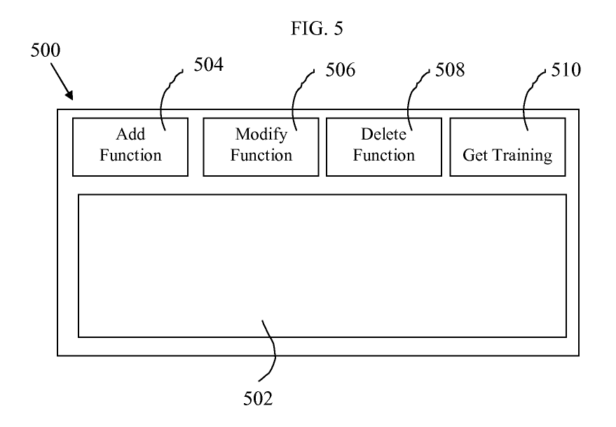

In certain embodiments, the structured library approach allows a user to customize a specific structured library of functions, through actions such as adding, modifying or deleting functions from the library. For example, in certain embodiments, a user interface can display a structured library and allow a user to customize the structured library. FIG. 5 depicts such a user interface 500. The user interface 500 includes a display area 502 configured to display a structured library, an add function button 504, a modify function button 506, a delete function button 508 and a get training button 510. In operation, user interface 500 can display a structured library in display area 502 and also display the add function button 504 that, upon selection, provides a list of available functions. A user can select a function from the list to be added to the structured library. A user can select a function in the structured library and then select the delete button 508 (or hit the delete key on a keyboard) to delete the selected function from the structured library. A user can select a function in the structured library and then select the modify function button 506 that, upon selection, can allow the user to modify the user input that is associated with the function. For example, a new user input can be received at a touch based interface that can then be associated with the function. A user can select a function in the structured library and then select the get training button 510 that, upon selection, can open a training dialogue that can instruct as to using the selected function.

In certain embodiments, the user is able to load or unload a customized structured library of functions from a specific system or clinical context. This would also enable the user to share the customized structured library of functions with other users and/or systems. For example, in certain embodiments, a customized structured library can be written to portable file and/or memory that can be transferred to another system and loaded thereon.

In certain embodiments, such as the embodiment described above in connection with FIG. 5, the system would include functionality to train a user on the use of a specific customized structured library of functions. For example, in certain embodiments, a user can be prompted to receive training for a customized structured library of functions if the library is newly loaded. In certain embodiments, training can be accessed using a system help menu, a user manual or a system online help.

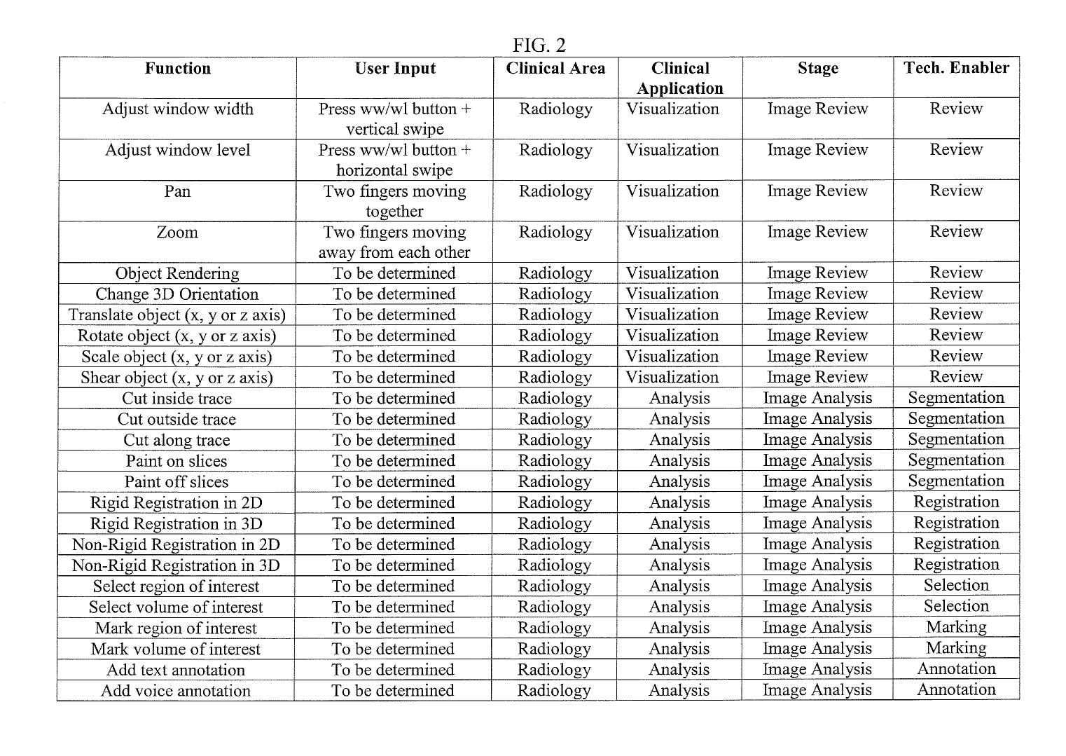

FIG. 2 is a table depicting a structured library of functions used in accordance with embodiments of the present technology. The structured library depicted in FIG. 2 includes functions and clinical contexts that would be useful to a Neuro-radiologist when analyzing prior data and current data to detect nodule growth, for example. Such functions may be useful in other clinical contexts, for example, as described herein. FIG. 2 includes columns for function, user input, clinical area, clinical application, stage and technology enabler. Certain user inputs are indicated as “to be determined.” Any suitable user input could be used in such cases. While FIG. 2 depicts a clinical area of “radiology” and clinical applications of “Visualization” and “Analysis” any clinical areas or clinical applications could be set up in a similar format in order to create a structured library of functions, user inputs and clinical context. Likewise, while FIG. 2 depicts workflow stages of “image review” and “image analysis” and technology enablers of “reviewing,” “segmentation,” “registration,” “selecting,” “marking,” and “annotating,” any workflow stages or technology enablers could be set up in a similar format in order to create a structured library of functions, user inputs and clinical context.

Examples of clinical areas can include, for example: radiology, surgery, interventional radiology, patient monitoring, neurology (visualization and analysis of the brain and spine), cardiology (visualization and analysis of the heart, including cardiac vessels, etc.), vascular (visualization and analysis of vascular extremities, etc.), oncology (visualization and analysis of the breast, lung, colon, prostate, liver, etc.), and/or musculoskeletal (visualization and analysis of joints (knees, etc.), cartilage, physis, etc.).

Examples of clinical applications can include, for example: visualization, analysis, quantitation, detection, monitoring or differential diagnosis. In connection with performing feature detection, a region of interest segmentation can be performed before feature detection/identification. Optionally, one can perform quantitative analysis prior to classification for differential diagnosis. Following such processing and analysis, where desired, features may be identified in the data. While such feature identification may be accomplished on imaging data to identify specific anatomies or pathologies, it should be understood that the feature identification carried out may be much broader in nature. For example, due to the wide range of data which may be integrated into the inventive system, feature identification may include associations of data, such as clinical data from all types of modalities, non-clinical data, demographic data, and so forth. In general, the feature identification may include any sort of recognition of correlations between the data that may be of interest for the processes carried out by an application. The features are segmented or circumscribed in a general manner. Again, in image data such feature segmentation may identify the limits of anatomies or pathologies, and so forth. More generally, however, the segmentation carried out is intended to simply discern the limits of any type of feature, including various relationships between data, extents of correlations, and so forth.

In connection with performing feature classification for differential diagnosis, feature classification can include comparison of profiles in the segmented feature with known profiles for known conditions. The classification may generally result from parameter settings, values, and so forth which match such profiles in a known population of datasets with a dataset under consideration. However, the classification may also be based upon non-parametric profile matching, such as through trend analysis for a particular patient or population of patients over time.

In connection with performing monitoring, monitoring can be performed through trend analysis of a particular patient data over time. In one embodiment, the clinical application may be for assessing a patient's condition for detecting a change over time. In another embodiment, the clinical application can be for determining the efficacy of a therapy over time. Monitoring is usually performed on a registered data set at two or more time intervals.

In connection with performing quantitation, quantitation can include quantitative information derived from the data. For example, from a radiological image of a brain tumor, the clinical application may extract quantitative information such as tumor size, tumor volume, surface area, pixel density, etc. In some embodiments, the quantitative information may include texture measures, shape measures, and point, linear, area, volume measures. In other cases, it may include physical parameters such as velocity, temperature, pressure computed from the data.

Examples of stages in a technology workflow under the clinical area of “radiology” can include, for example: screening (used in the screening of patients to determine whether radiology exams and reviews are required), scheduling (used to assist in scheduling patients for the specific radiology exams required based on screening results), image acquisition (used for actual exam acquisition, and including specification of scan protocols and settings), data reconstruction (used for reconstruction of raw data acquired from scans), image processing (application of various processing techniques on reconstructed scan results), image display (tools used to visualize results for the radiologist), image analysis (tools to analyze visualized results including saving markings, annotations, comments, etc. from the reader), image storage (archiving of scan and analysis results in a storage medium, such as a central hospital database), image retrieval (retrieval of scan and analysis results in a storage medium, such as a central hospital database), diagnosis (diagnosis and decisions arising from review and analysis of radiology exams), report creation (tools to collaborate and create reports from radiology exam results), and/or result dissemination (tools to aid in communicating reports and results to the patient).

Examples of technology enablers under the clinical area of “radiology” can include, for example: reviewing, segmentation, registration, selecting, marking, and annotation. In the radiology context, reviewing refers to displaying and reviewing of radiology exams. The functions to be made available can include those that aid in controlling display aspects, such as adjusting display parameters and/or using visualization tools for window width/window level, pan/zoom, object rendering, and/or changing 3D orientation, for example. The functions to be made available can also include those that aid in manipulating objects visualized, such as moving objects under review (either manually or computer assisted) in the following degrees of freedom: translating in x, y and z axes, rotating in x, y and z axes, scaling in x, y and z axes, and/or shearing in x, y and z axes, for example. In the radiology context, segmentation refers to segmentation of radiology exams. The functions to be made available can include those described above for reviewing and also include functions for cutting inside/outside/along traces, painting on/off slices, undoing previous actions, and/or selecting multiple objects, for example. In the radiology context, registration refers to registration of radiology exams. The functions to be made available can include those described above for reviewing and also include functions for manipulating multiple objects from one or more sources, performing rigid and non-rigid registration in 2D & 3D on all or part of the objects of interest, for example. In the radiology context, marking, selecting and annotation refers to marking, selecting and annotation of radiology exams. The functions to be made available can include those described above for reviewing and also include functions for marking and selecting regions/volumes of interest, making annotations (text, voice, etc.), taking notes for future analysis and review, for example.

While the preceding examples discuss the “radiology” context, similar functions can be provided in other contexts in order to similarly provide a structured library of functions. Also, other functions can be included in a radiology context to similarly provide a structured library of functions. To this end, a structured library of functions can be customized in order to accommodate specific clinical contexts.

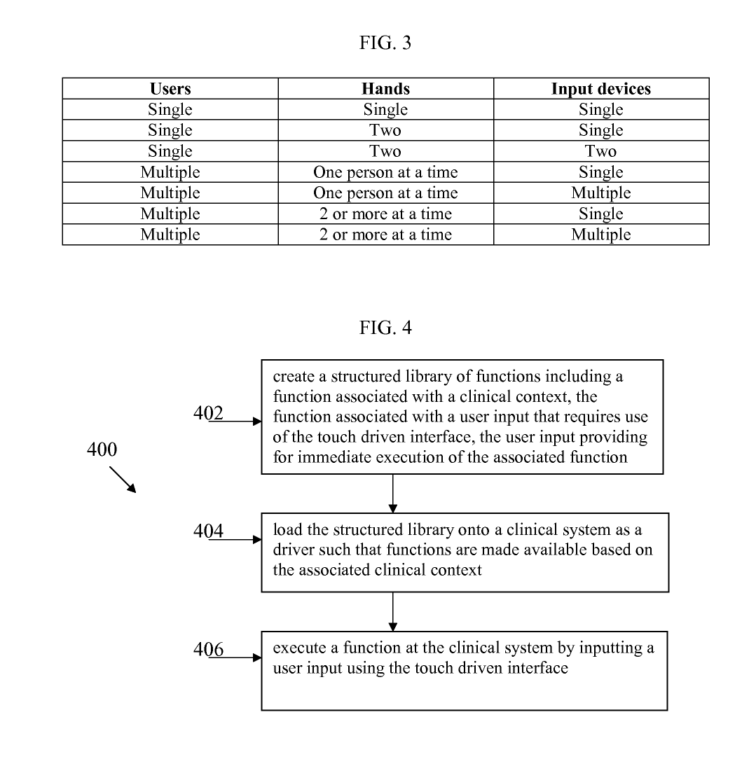

FIG. 3 is a table depicting various combinations of user inputs and devices used in accordance with embodiments of the present technology. The table includes columns for users (single or multiple), hands (needed for the user input: single, two, one person at a time, 2 or more people at a time), and input devices (touch-driven interfaces: single, two, multiple). The table provides examples of types of user inputs that could be used to trigger a function. In certain embodiments, for example, a function can be triggered when a user (or multiple users) provide an input (or multiple simultaneous inputs) using a touch-driven interface (or multiple touch-driven interfaces or a combination of a touch-driven interfaces and other input devices that are not touch-driven interfaces) as appropriate for a clinical context based on a structured library of functions.

FIG. 4 depicts a flowchart for a method 400 for providing touch-driven controls in a clinical setting used in accordance with embodiments of the present technology. At 402, a structured library of functions is created. The structured library can include a function associated with a clinical context. The function can be associated with a user input that requires use of the touch driven interface. The user input can provide for immediate execution of the associated function. At 404, the structured library is loaded onto the clinical system as a driver such that functions are made available based on the associated clinical context. At 406, a function is executed at the clinical system by inputting a user input using the touch driven interface.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. For example, certain embodiments provide a computer-readable storage medium encoded with a set of instructions for execution on a processing device and associated processing logic, wherein the set of instructions includes a routine(s) configured to provide the functions described in connection with the method 400.

Applying the method 400 as described above, and/or in light of the embodiments described herein, for example, as described in connection with FIGS. 1-3, can provide customized touch-driven controls in a clinical setting.

Certain embodiments of the technology described herein provide a technical effect of providing customized touch-driven controls in a clinical setting.

Image data acquired, analyzed and displayed in connection with certain embodiments disclosed herein represents human anatomy. In other words, outputting a visual display based on such data comprises a transformation of underlying subject matter (such as an article or materials) to a different state.

While the inventions herein have been described with reference to embodiments, it will be understood by those skilled in the art that various changes may be made and equivalents may be substituted without departing from the scope of the inventions. In addition, many modifications may be made to adapt a particular situation or material to the teachings of the inventions without departing from their scope. Therefore, it is intended that the inventions not be limited to the particular embodiments disclosed, but that the inventions will include all embodiments falling within the scope of the appended claims.

1. A system for providing touch-driven controls in a clinical setting, the system comprising:
a clinical system comprising a processing device operably connected to a storage medium and a touch-driven interface; and
a customizable structured library of functions including a function associated with a clinical context, the function associated with a user input requiring the use of the touch driven interface with multi-touch gestures, the user input providing for immediate execution of the associated function, the structured library loaded onto the storage medium as a driver such that the function is made available based on the associated clinical context.

2. The system of claim 1, wherein the clinical context includes a clinical application in a clinical area.

3. The system of claim 2, wherein the clinical area includes at least one of: radiology, surgery, interventional radiology, patient monitoring, neurology, cardiology, vascular, oncology, or musculoskeletal.

4. The system of claim 2, wherein the clinical application includes at least one of: visualization, analysis, quantitation, detection, monitoring or differential diagnosis.

5. The system of claim 1, wherein the clinical context includes a stage in a technology workflow using a technology enabler.

6. The system of claim 5, wherein the stage in the technology workflow includes at least one of: screening, scheduling, image acquisition, data reconstruction, image processing, image display, image analysis, image storage, image retrieval, diagnosis, report creation, or result dissemination.

7. The system of claim 5, wherein the technology enabler includes at least one of: review, segmentation, registration, selection, marking, or annotation.

8. The system of claim 1, further comprising a user interface configured to allow: a function to be added to the structured library, a function to be deleted from the structured library, and a user input associated with a function to be modified.

9. The system of claim 1, further comprising a user interface configured to provide instruction as to using a function in the structured library.

10. The system of claim 1, wherein the touch-driven interface comprises at least one of: a touch-screen, or a touch-pad.

11. The system of claim 1, wherein the touch-driven interface comprises a multi-touch interface configured to receive a plurality of simultaneous inputs from a plurality of users, and wherein the user input requires that the plurality of simultaneous inputs from the plurality of users be received at the touch-driven interface.

12. A method for providing touch-driven controls in a clinical setting, the method comprising:
using a processing device to load a customizable structured library of functions onto a storage medium in a clinical system that comprises a touch-driven interface, the structured library of functions including a function associated with a clinical context, the function associated with a user input requiring the use of the touch driven interface with multi-touch gestures, the user input providing for immediate execution of the associated function, the structured library loaded onto the storage medium as a driver such that the function is made available based on the associated clinical context.

13. The method of claim 12, further including using a user interface to customize the structured library of functions.

14. The method of claim 12, further including executing a function at the clinical system when a user input is received at the touch driven interface.

15. The method of claim 12, wherein the touch-driven interface comprises a multi-touch interface configured to receive a plurality of simultaneous inputs from a plurality of users, and wherein the user input received at the touch-driven interface is the plurality of simultaneous inputs from the plurality of users.

16. The method of claim 12, wherein the touch-driven interface comprises at least one of: a touch-screen, or a touch-pad.

17. The method of claim 12, further including using a user interface to provide instruction as to using a function in the structured library.

18. A computer-readable storage medium encoded with a set of instructions for execution on a processing device and associated processing logic, wherein the set of instructions includes:
a first routine configured to load a customizable structured library of functions onto a storage medium in a clinical system that comprises a touch-driven interface, the structured library of functions including a function associated with a clinical context, the function associated with a user input requiring the use of the touch driven interface with multi-touch gestures, the user input providing for immediate execution of the associated function, the structured library loaded onto the storage medium as a driver such that the function is made available based on the associated clinical context.

19. The computer-readable storage medium encoded with a set of instructions of claim 18, further including a second routine configured to allow the structured library to be customized.

20. The computer-readable storage medium encoded with a set of instructions of claim 18, further including a second routine configured to provide instruction as to using a function in the structured library.
